(19) United States
(12) Patent Application Publication
(10) Pub. No.: US 2002/0029097 A1
(43) Pub. Date: Mar. 7, 2002

(54) Wind farm control system

(76) Inventors: Dino J. Pionzio JR., Barcelona (ES); Curt W. Peterson, Marina Del Rey, CA (US); David L. Barnes, Alpine, CA (US); William J. Libby, San Diego, CA (US); Mark I. Lee, Zurich (CH); Benjamin Reeve, Arlington, MA (US)

Correspondence Address: HANS R. TROESCH, Fish & Richardson P.C., Suite 100, 2200 Sand Hill Road, Menlo Park, CA, 94025, US

(21) Appl. No.: 09/828,500

(22) Filed: Apr. 6, 2001

Related U.S. Application Data
(60) Provisional application No. 60/207,722, filed on May 26, 2000.
(60) Provisional application No. 60/195,743, filed on Apr. 7, 2000.

(51) Int. Cl. G05D 11/00

(52) U.S. Cl. 700/286; 700/287

(57) ABSTRACT

A Supervisory Command and Data Acquisition (SCADA) system for managing wind turbines for electric power generation. One implementation includes a SCADA element at each wind turbine, configured to collect data and provide an interface to control the turbine and communicate with other parts of the system; a SCADA element at a substation, configured to collect data from the substation, to communicate with other parts of the system, and to store substation data locally; a SCADA element at each meteorological site, configured to collect meteorological data from sensors on and at a meteorology tower, to communicate with other parts of the system, and to store meteorology data locally; a data communication network; a server coupled over the network with the wind turbines, the substation, and the meteorological sites through their respective the SCADA elements; and a user interface through which authorized users can exercise command and control functions.

### RELATED APPLICATIONS

The present application claims priority to U.S. Patent Applications No. 60/207,722, filed May 26, 2000, and No. 60/195,743, filed Apr. 7, 2000. In the United States, the priority claim is made under 35 U.S.C. § 119(e) and the disclosures of the priority applications are incorporated here by reference.

### BACKGROUND OF THE INVENTION

The invention relates to SCADA (Supervisory Command and Data Acquisition) systems in the context of commercial electric power generation.

A wind farm of wind turbines operated for commercial electric power generation requires a considerable infrastructure to support control and monitoring functionality of the wind turbines and utility interconnect. In general, the manufacturers of wind turbines offer only wind turbine controllers and related command and control systems that are specific to their turbine products. Such offerings generally provide little or no means for integrating the products or systems of one manufacturer with those of another. Such offerings also generally provide only an engineering view of the operation of a wind farm rather than a business or financial view.

Thus, there is a need for a SCADA system that can be used in a cost effective and efficient manner to operate a reliable and profitable wind farm.

### SUMMARY OF THE INVENTION

In general, in one aspect, the invention provides a Supervisory Command and Data Acquisition (SCADA) system for managing wind turbines for electric power generation. One implementation includes a SCADA element at each wind turbine, configured to collect data and provide an interface to control the turbine and communicate with other parts of the system; a SCADA element at a substation, configured to collect data from the substation, to communicate with other parts of the system, and to store substation data locally; a SCADA element at each meteorological site, configured to collect meteorological data from sensors on and at a meteorology tower, to communicate with other parts of the system, and to store meteorology data locally; a data communication network; a server coupled over the network with the wind turbines, the substation, and the meteorological sites through their respective the SCADA elements; and a user interface through which authorized users can exercise command and control functions.

In general, in another aspect, the invention provides a system for managing a wind farm having an array of wind turbines for electric power generation. The system includes a SCADA element at each wind turbine configured to collect data from the turbine; a SCADA element at each of one or more meteorological sites configured to collect meteorological data; and a SCADA element at each of one or more substations, the substations being electrically connected with the wind turbines for power transmission; and a server coupled to communicate with the wind turbine, meteorological, and substation SCADA elements. The server is configured to receive and to store data received from the elements at regular intervals and to perform database management on the received data, and to gather and maintain detailed current and historical data as to the inputs, operating conditions, and outputs of all turbines of the wind farm at a high degree of time resolution.

The invention can be implemented to realize one or more of the following advantages. A person working on any part of the wind power system can use a portable device to connect to a local controller, such as a turbine processing unit at a turbine site, through a direct connection, such as an RS232 interface, and through the controller communicate with any other component of the system through the user interface of the system. A controller can be connected to the system through any interface that supports TCP/IP (Transmission Control Protocol/Internet Protocol). Local storage of data provides fault tolerant data acquisition, ensuring no loss of data. The use of configuration databases allows an operator to perform real-time system configuration without interfering with system operation. For example, system can continue to monitor and process data while an operator is adding or subtracting turbines from the system database.

The design also allows for seamless integration with any other program products that can access the databases of the system.

Because system reliably gathers and maintains detailed current and historical information as to the inputs, operating conditions, and outputs of all components at a high degree of time resolution, the system provides the detailed information needed for predictive analysis, performance analysis, and model design and verification for a variety of model types, such as financial, airflow, process, and mechanical.

Having computing and data storage resources in the on-site controllers such as the turbine processing units allows sophisticated data processing. monitoring, and control functions to be performed in a highly scalable way and on data gathered at a very high data rate.

Because of its modular and open design, the system can be implemented using a variety of alternative technologies.

The details of one or more implementations of the invention are set forth in the accompanying drawings and the description below. Other features and advantages of the invention will become apparent from the description, the drawings, and the claims.

### BRIEF DESCRIPTION OF THE DRAWINGS

FIG. 1 (made up of FIG. 1A and FIG. 1B) is a schematic diagram of a wind farm control system in accordance with the invention.

FIG. 2 is a schematic diagram of a Turbine Processing Unit (TPU) in accordance with the invention associated with a turbine tower.

FIG. 3 is a schematic diagram of a meteorology tower associated with the system in accordance with the invention.

FIG. 4 is a schematic diagram illustrating the components and interfaces used for data collection on a meteorology tower.

FIG. 5 is a schematic diagram of the principal subsystems of the system.

FIG. 6 is a schematic diagram illustrating a top-level architecture of a central server of the system.

Like reference symbols in the various drawings indicate like elements.

### DETAILED DESCRIPTION

This specification describes a system for managing an array of wind turbines of the kind deployed for electric power generation on a commercial scale. The system is called TACS (Turbine Array Control System).

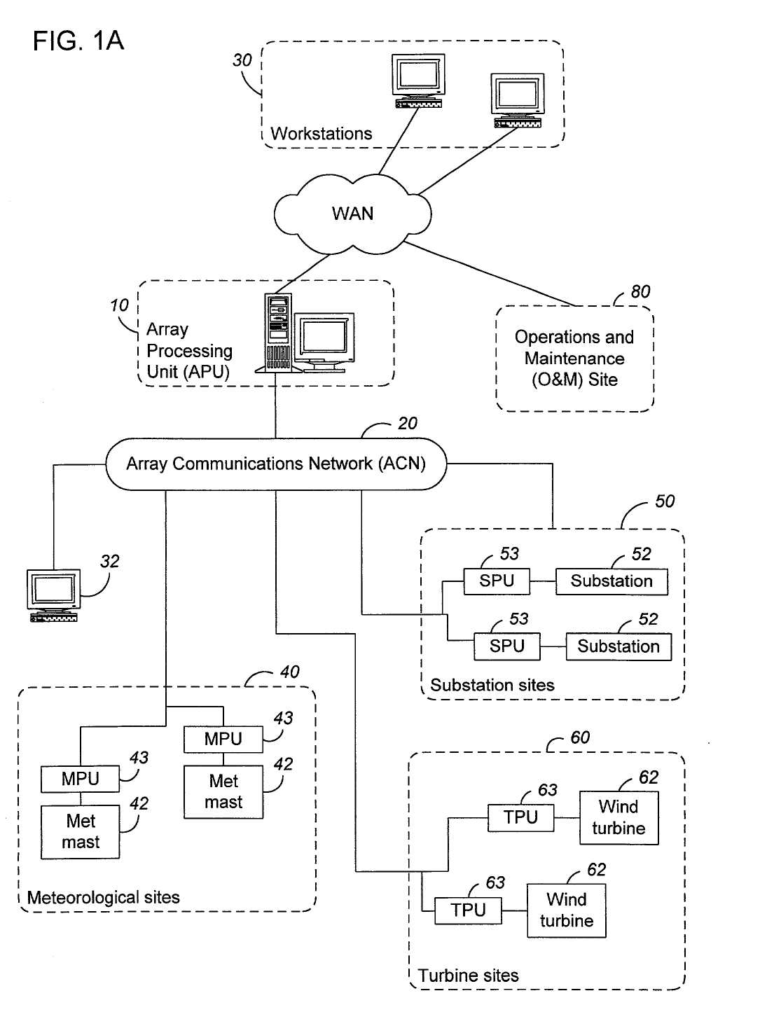

As shown in FIG. 1, a turbine array and TACS can be viewed as a Supervisory Command and Data Acquisition (SCADA) system. The six primary entities of a wind power system are the Array Processing Unit (APU) 10, Array Communications Network (ACN) 20, workstations 30 and 31, meteorological sites 40, power substation sites 50 and turbine sites 60. Workstations 31 can be located in an operations and maintenance (O&M) site 80 remotely over a wide area network (WAN) and can be directly connected directly to the network, as is workstation 32. (An “array” or “turbine array” is a group, which may be widely dispersed, of wind turbines 62 and related equipment. A “site” is a logical grouping of all equipment and components at a physical location.) The architecture of TACS provides high performance monitoring and control, as well as excellent expansion capability with support for virtually any number and/or type of devices.

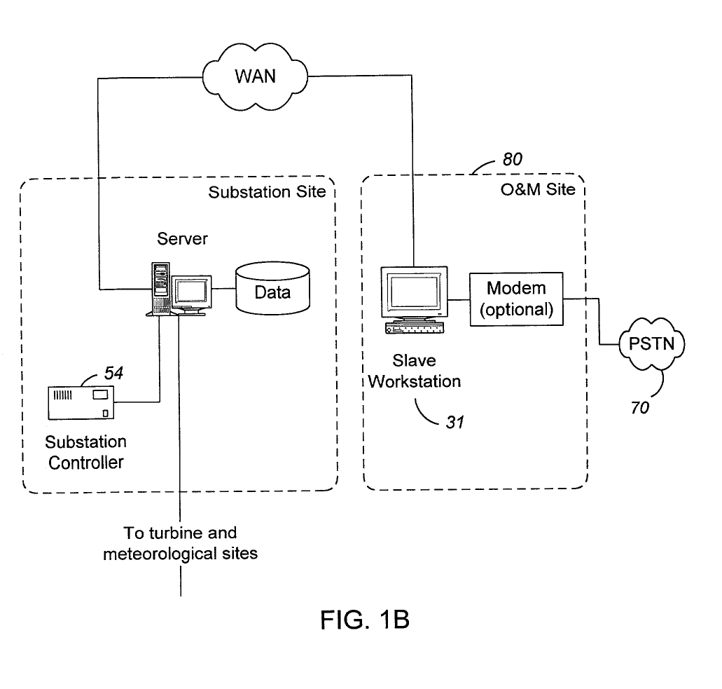

Site entities each contain one or more processing elements along with the equipment being monitored and/or controlled. Turbine sites have one or more turbine towers 200 (FIG. 2), with each turbine tower containing a Turbine Processing Unit 63 (TPU) functioning as the SCADA element for that tower 200 or wind turbine 63. Substation sites 50 and meteorological sites 40 each contain a processing element referred to as the Substation Processing Unit 53 (SPU) and Meteorological Processing Unit 43 (MPU), respectively, again functioning as the SCADA element for the particular site.

TACS collects and stores raw data from the sites. The data is used for real time display and preserved in long term storage. TACS reduces the raw data and presents it for analysis to operations and financial personnel.

TACS provides both manual and automatic controls of the wind turbines and the substation or substations through which energy is delivered to the electric power grid. The turbines and substations can be controlled both manually and automatically. Automatic control can be based on power production. TACS provides a mechanism to modify the state of the discrete outputs of the substation interface manually with a check for reasonableness and security. TACS provides a configuration interface to the control algorithm to limit energy output to the substation based on time and power limits that will automatically shut off the appropriate number of turbines.

TACS includes a network 20 designed to ensure continuous communication. The network is a managed Ethernet star configuration. In case of a network failure, each TACS subsystem is able to store its raw data locally. TACS provides an interface to monitor and control the network and uninterruptible power supplies for the units. TACS supports remote network access. The wind turbine processors 210 also provide remote network access to support on site operations access of remote systems.

TACS notifies personnel of any major alarms that may occur. A graphical user interface provides an interface to alarms, alarm definitions and notification instructions.

The Array Processing Unit (APU) Shown in FIG. 1, the Array Processing Unit (APU) 10 is also referred to as the server.

The APU executes application programming, which will be described below, that is responsible for collecting data from and controlling the elements of the wind power system. The APU application is built on the client-server architecture where the APU is referred to as the server and the site entities are referred to as the clients.

The site entities are connected to the APU over a standard Ethernet network. The transport medium is optical fiber to eliminate electromagnetic and radio frequency interference, ground loops and other sources of interference present in an industrial environment.

Workstations 30 and 31 execute a Microsoft Windows NT application that processes the data from the APU into various reports and allows real-time monitoring and control of the wind power system. The term “workstation” is used to refer to client computers of any kind, including ordinary personal computers, laptop computers, personal digital assistants, and so on. Workstations with remote access provide a subset of the functionality of local workstations and are primarily used for site administration (e.g., software updates); however, remote access workstations—which connect to TACS through the public switched telephone network 70, for example—can be used as replacements for, or in addition to, the local workstations. Thus, an O&M site 80 can be located remotely (FIG. 1B).

Site-based processing elements or units execute a client application providing local data collection and site control. Each processing unit functions mainly as a store and forward device with alarm processing and local measurement data storage sufficient to bridge any anticipated unavailability of the server. Remote system administration can be performed from any standard PC connected to the network using standard Windows NT tools.

Monitoring Data

The APU provides database management and reporting functions. It collects data from all network components at frequent intervals, at least once a minute. It collects data (controller state, wind speed, energy levels, alarms, and so on) from the wind turbine controller 220 at a high frequency, such as once a second.

The APU collects and stores meteorological data (vertical and horizontal wind speeds, wind direction, temperature, pressure, battery level) from all towers once every 30 seconds.

The APU collects and stores substation data from the SPU once a second.

Processing Data

The APU also performs data processing functions. For example, it computes and stores meteorology and power production measurement data for each turbine and park.

A “park” is a grouping of turbines, which may be logical or physical. In the particular implementation being described, parks are defined to group physically-related turbines. However, parks can also be defined along other lines, for example, to group financial or ownership interests, contractual obligations, equipment types, and so on. With parks of different kinds, an array of turbines can be subdivided into multiple sets of parks for reporting and management purposes.

The APU computes and stores the availability for each turbine and park; it computes and stores the alarms which must be sent for notification; it computes and stores the actual energy produced for each turbine and park; it computes and stores the efficiencies of each turbine and park; it computes and stores the averages for the last 10 minutes and the last hour and the minima and maxima of the meteorological data for the day each time the data is collected; it computes and stores the scaled units of the substation data from substation analog inputs; and it computes and stores the line losses, active and reactive power, input power and output power for all the circuits and totals for the current data, the last 10 minutes, the last hour, and the last day. The APU also allows an authorized user to display and compare any of the collected and computed data through a graphical user interface.

The APU computes and stores alarms including alarms that must be sent to notify personnel. These include alarms from the meteorology data (e.g., battery level, data inconsistencies, data out of range), substation interface alarms, alarms from the server data (e.g., uninterruptible power supply, operation system, database, and disk drives), and other alarms (e.g., communications errors, data rates out of range, out of range values and uninterruptible power supplies states).

System Control

The APU provides a variety of tools for users to control operation of the wind power system. For example, the APU provides an interface for a user to control each turbine, subject to limits of reasonableness and security, including functions to start, stop, reset, yaw, and request alarms. The APU allows an authorized user to configure the control algorithm to limit energy output to the substation based on time and power limits that will automatically shut off the appropriate number of turbines.

The APU allows an authorized user to modify manually the state of the discrete outputs of the substation interface, with a check for reasonableness and security, and to configure automatic controls of substation transformers.

The APU allows an authorized user to configure levels of authority of system users. User Interface The APU provides a graphical user interface (GUT) that provides multi-level menus that allow an authorized user to exercise command and control functions for the wind power system. The GUI updates the turbine data display at a configurable rate with a default of once every 5 seconds. The GUT displays the meteorology and power production measurement data for each turbine and park, including, e.g., wind speed and energy levels. The GUT can display the availability for every turbine and park, the alarms (active and acknowledged) from every turbine for up to a period of one month, the efficiency data of each turbine and park, the state of the communication link to each turbine, the energy produced for every turbine and park, and the real and reactive power for every park.

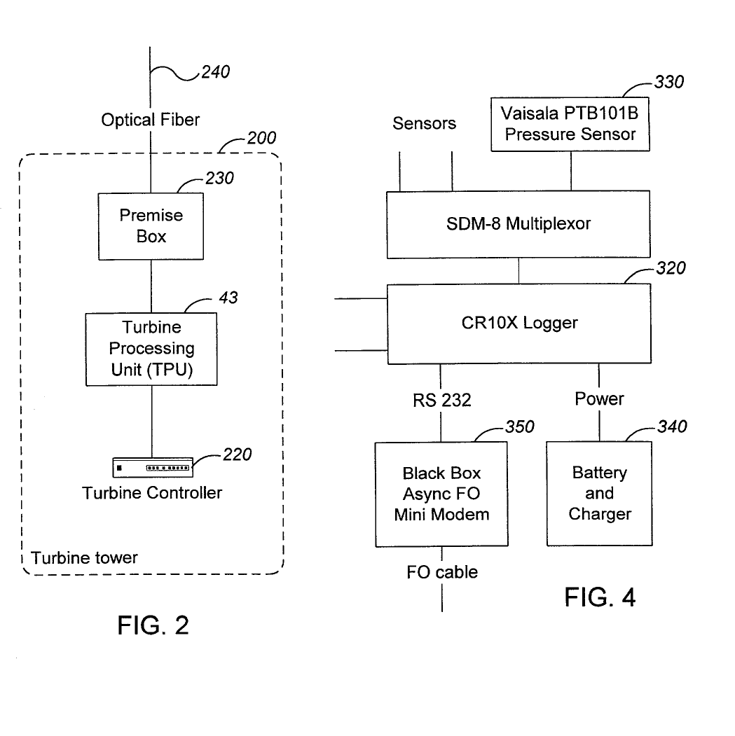

The GUT also displays the meteorological data (vertical and horizontal wind speeds, wind direction, temperature, pressure, battery level) from all meteorology towers (FIG. 3), including the current meteorological data, last 10 minutes averages, last hour averages and the minima and maxima for the day, and the alarms (active and acknowledged) from the meteorological data (e.g., battery level, data inconsistencies, data out of range).

The GUT also displays the data from the substation interface. The GUT displays the line losses, active and reactive power, input power and output power for all the circuits and totals for the current data, the last 10 minutes, the last hour and the last day. The GUT also allows authorized users to control a substation.

The GUI provides an interface to acknowledge and classify alarms, to compute totals and display the alarm data, to create and modify alarm set points of the meteorological data, to configure which data will set alarms when out of range or unreasonable, and to configure which alarms will be sent to personnel for notification. The APU has an alarm notification system that will transmit alarms to the appropriate personnel. This system can provide visual and/or audible indication to a user from the user interface and remotely with announcements through telephone calls, e-mail messages, and pager messages. The GUI user will always have a view of any unacknowledged alarms for all components in the wind power system. When a component is detected with a critical event, the component name with an alarm icon will be displayed prominently in the alarm window on the front panel of the GUI. By clicking on the alarm icon, the user is taken to the event view of the component with the error.

The GUI also displays the status of the uninterruptible power supply of the server and the distributed units of the system. It supports levels of authority for data access to the system users, and it provides a standard ODBC (Open Database Connectivity) interface to all data in the measurement database.

### Turbine Processing Unit (TPU)

As shown in FIG. 2, a Turbine Processing Unit (TPU) 210 is associated with, and located close to, a turbine tower 200. It provides an interface between the generally-proprietary turbine controller 220 provided by the turbine manufacturer and the rest of the system. The TPU may optionally connect to the system through a premise box 230 providing a physical interface between the optical fiber 240 of the system network and the TPU 210, which can be connected to the premise box with a fiber patch cable. The TPU 210 and the turbine controller 220 can be connected using an optically isolated RS-232 connection.

A TPU performs the functions of data monitoring, system control, and communications at a turbine site. It collects data, such as controller state, wind speed, energy levels, and alarms, from the controller at a rate of once a second. It provides an interface to control each turbine.

A TPU interacts with the system through an Ethernet port and, as required, with workers who may be working at the TPU, through optically isolated serial ports.

TPU software runs on a Microsoft Windows NT Embedded operating system. All software components of a TPU operate as Windows NT services allowing them to run at an administrator permissions level on system startup.

Wind Turbine Controller Protocol

A TPU interacts with its turbine through a turbine controller, which is generally an off-the-shelf item provided with the turbine by the turbine manufacturer. The TPU implements a transport layer communication protocol for the turbine controller, providing a uniform interface to the system from any of a variety of turbines and controllers. The TPU-controller protocol implementation that is described below is for a controller made by KK Electronic A/S and provided by Bonus Energy A/S, both of Denmark. The protocol is a combination of network and data transport layers, and as such, it may be transmitted over any suitable physical medium.

The basic protocol follows a command-response format, whereby each packet transmitted by the master is acknowledged by the slave. Communication is initiated and controlled by the master. The protocol is entirely ASCII (text) based. Packet retransmission and cyclic redundancy checks (CRCs) are used to minimize data corruption and errors.

The master initiates communications with a particular slave by sending the start of transmission (SOT) sequence, a ‘$’ followed by the two digit turbine ID in hexadecimal notation (e.g., $01). The corresponding turbine responds with the ready to receive (RTR) sequence, an ‘*’ followed by its two digit turbine ID in hexadecimal notation (e.g., *01). If the slave does not respond, or an incorrect turbine ID is received, the master will time out. Thus, a complete command sequences made up of the SOT sequence, followed by a directive and a datafile of the associated type, terminated by either a data acceptance sequence or a transmission retry timeout. A datafile is the payload of a message. Datafile types are described below. Command sequences may be initiated indefinitely.

The master can send four directives representing command request, data request, memory write or memory read. Directives are sent immediately following a valid SOT sequence. Data acceptance is signaled by transmission of the “closing character” matching the “opening character” sent for the specific directive. Upon receipt of this character the communications sequence is terminated.

A command (CRD) request is initiated by sending a single ASCII ‘(’ denoting the start of the datafile, followed immediately by a datafile type 1 structure. The specific command is contained in the datafile. Upon acceptance of data, the slave transmits a single ASCII ‘)’ to the master, terminating the communications sequence.

A data request (DRD) is initiated by sending the data request sequence, namely, an ‘&’ followed by the two digit turbine ID in hexadecimal notation (e.g., &01). The slave responds with the requested data by sending a single ASCII ‘[’ denoting the start of the datafile, followed immediately by a datafile type 2 structure. The specific data is contained in the datafile. Upon acceptance of data, the master transmits a single ASCII ‘]’ to the slave, terminating the communications sequence.

A memory write (MWD) is initiated by sending a single ASCII ‘{’ denoting the start of the datafile, followed immediately by a datafile type 3 structure. Upon acceptance of data, the slave transmits a single ASCII ‘}’ to the master, terminating the communications sequence.

A memory read (MRD) is initiated by sending the memory read sequence, a ‘#’ followed by the two digit turbine ID in hexadecimal notation (e.g., #01). The slave responds with the requested data by sending a single ASCII ‘[’ denoting the start of the datafile, followed immediately by a datafile type 4 structure. The specific data is contained in the datafile. Upon acceptance of data, the master transmits a single ASCII ‘]’ to the slave, terminating the communications sequence.

If a datafile transmitted by the master is not accepted by the slave, the slave will respond with a single ASCII character ‘?’ and wait for a retransmission.

If a datafile transmitted by the slave is not accepted by the master, the master will respond with a single ASCII character ‘“’ and wait for a retransmission.

Datafile Structures

A datafile contains the specified data and a CRC and is terminated with an end of transmission character (0×04). Each field is separated by a single ASCII ‘/’.

Datafile 1

A datafile 1 is used to request specific data from the turbine controller and to command the controller for manual operation. In this implementation, the type is command request data; the direction, master to slave; the size, 11 characters. The commands that can be carried include the following.

| Char | Description |
|---|---|
| C | Computer reset |
| B | Brake turbine |
| R | Yaw CW (clockwise) |
| L | Yaw CCW (counterclockwise) |
| T | Do not care |
| S | Start automatic operation |
| M | Motor start turbine |
| Q | Quit fault code (acknowledge) |
| A | Move alarm stack pointer to newest |

Datafile 2

A datafile 2 contains data returned from the controller. The fields all have a fixed length and the message contains all fields regardless of content. In this implementation, the type is command response data; the direction, slave to master; the size, 208 characters. The data fields of a datafile 2 function are shown in the following tables 1-6.

TABLE 1
Field Definitions

| Field Name | Range | Units |
|---|---|---|
| Year | 00-99 | Years |
| Month | 01-12 | Months |
| Day | 01-31 | Days |
| Hours | 00-12 | Hrs. |
| Minutes | 00-59 | Min. |
| Turbine status | see Table 2 | |
| Brake status | see Table 3 | |
| Generator status | see Table 4 | |
| Yaw timer | −32765 −+ 32765 (1/10 sec.) | Sec. |
| | ‘−’ = CCW, ‘+’ = CW | |
| Power | 0000.0-9999.9 | kW |
| Reactive power | −999.9-+999.9 | KVar |
| Power factor | −9.99-+9.99 | |
| Wind speed | 00.0-99.9 | m/s |
| Grid frequency | 00.0-99.9 | Hz |
| Generator RPM | 0000-9999 | RPM |
| Rotor RPM | 00-99 | RPM |
| Generator 1 temp. | −99-150 | ° C. |
| Generator 2 temp. | −99-150 | ° C. |
| Gearbox temp. | −99-150 | ° C. |
| Ambient temp. | −99-150 | ° C. |
| Phase R voltage | 000-999 | V |
| Phase S voltage | 000-999 | V |
| Phase T voltage | 000-999 | V |
| Phase R current | 000-999 | A |
| Phase S current | 000-999 | A |
| Phase T current | 000-999 | A |
| Energy subtotal gen. 1 | 000000000-999999999 | KWh |
| Prod. time subtotal gen. 1 | 000000-999999 | Hrs. |
| Energy subtotal gen. 2 | 000000000-999999999 | KWh |
| Prod. time subtotal gen. 2 | 000000-999999 | Hrs. |
| Energy total gen. 1 | 000000000-999999999 | KWh |
| Prod. time total gen. 1 | 000000-999999 | Hrs. |
| Energy total gen. 2 | 000000000-999999999 | KWh |
| Prod. time total gen. 2 | 000000-999999 | Hrs. |
| Safety switch | 0 = remote, 1 = local | |
| Operation code | see Table 6 | |
| Error code | see Table 5 | |
| Last error year | 00-99 | Years |
| Last error month | 01-12 | Months |
| last error day | 01-31 | Days |
| last error hour | 00-23 | Hrs. |
| last error minute | 00-59 | Min. |
| last error seconds | 00-59 | Sec. |

TABLE 2
Turbine Status Codes

| Code | Description |
|---|---|
| F | Fault condition |
| S | Out of work, must be started manually |
| W | Too strong wind to operate |
| w | Too strong wind to start |
| R | Cables are twisted automatically clockwise (CW), sensor |
| L | Cables are twisted automatically counter-clockwise (CCW), sensor |
| r | Cables are twisted automatically CW, yaw timer |
| l | Cables are twisted automatically CCW, yaw timer |
| s | Stopped for twisting, waiting for less wind speed |
| M | Manual motor start in progress |
| A | Automatic motor start in progress |
| O | Not yawed up in the wind yet |
| P | Start at wind limit for bypass small generator |
| t | Control time for wind speed before start |
| b | Wind enough for automatic start and motor start |
| * | No operation, wind too weak |

TABLE 3
Brake Status

| Code | Description |
|---|---|
| B | Brake pulled |
| b | Not sufficient pressure yet |
| = | Brake released |

TABLE 4
Generator Status

| Code | Description |
|---|---|
| G | Large generator cut in |
| I | Large generator cutting in |
| g | Small generator cut in |
| i | Small generator cutting in |
| m | Motor start on generator |
| t | Motor start not allowed in 7.5 min. |
| * | Generator is inactive |

TABLE 5
Error Codes

| Code | Description |
|---|---|
| 00 | System Faultless |
| 01 | 24 volt control voltage cut off |
| 02 | Uncontrolled yawing 24 volt cut off |
| 03 | Software watchdog error |
| 04 | Cut out error on large generator, free wheeling |
| 05 | Brake time exceeded, free wheeling |
| 06 | Large generator time cut out |
| 07 | Error temperature measurement |
| 08 | Anemometer error |
| 09 | Ambient temperature less than −20 degrees |
| 10 | Yaw motor superheated |
| 11 | Yaw contactor or thermal error |
| 12 | Cable twist sensor activation error |
| 13 | Continuous yaw limit exceeded |
| 14 | Frequency error on mains |
| 15 | Asymmetry in current |
| 16 | Voltage error on mains |
| 17 | Vibration sensor activated |
| 18 | Oil level in gearbox too low |
| 19 | Pressure in brake system too low |
| 20 | Hydraulic pump error |
| 21 | Worn or overloaded brake blocks |
| 22 | Thermally cut out large generator |
| 23 | Large generator RPM sensor error |
| 24 | Generator contactor error |
| 25 | By pass contactor error |
| 26 | RPM on rotor has exceeded max limit |
| 27 | Main bearings superheated |
| 28 | Main shaft RPM sensor error |
| 29 | Motor start not succeeded 5 times |
| 30 | Large generator superheated |
| 31 | Oil in gearbox superheated |
| 32 | Thyristors superheated |
| 33 | Overproduction in large generator |
| 34 | Current asymmetry in small generator |
| 35 | Small generator thermally cut out |
| 36 | Belt error or RPM sensor error, small generator |
| 37 | Motor start RPM limit exceeded |
| 38 | Small generator superheated |
| 39 | Sequential error |
| 40 | Error during performance of averaging |

TABLE 6
Operation Codes

| Code | Description |
|---|---|
| 00 | Normal operation |
| 01 | Operational stop with automatic start |
| 02 | Motor start cut out due to fault |
| 03 | Small generator cut out due to fault |
| 04 | Stopped for manual start |
| 05 | Stopped has to be restarted |
| 06 | Free wheeling has to be restarted by reset |

Datafile 3

A datafile 3 is used for setting the onboard clock, averaging times for data collection, and adjusting limits and control values. If the contents of the data field is ‘XXXXX’, the memory location will not be written, but the address is selected for reading on the following memory read directive. This function performs word writes only. In this implementation, the type is memory write data; the direction, master to slave; the size, 20 characters.

Datafile 4

A datafile 4 reads data from the selected memory location. The function is used to view data not available in the standard datafile 2 payload. In this implementation, the type is memory read data; the direction, slave to master; the size, 20 characters.

### Meteorological Processing Unit (MPU)

As illustrated in FIG. 3, a Meteorological Processing Unit 43 (MPU) provides meteorological data from sensors 310-319 on and at a meteorology tower through a data logger. The MPU collects and stores meteorology tower data, such as vertical and horizontal wind speeds, wind direction, temperature, pressure, and battery level, from all the towers regularly, such as once every 30 seconds.

As illustrated in FIG. 3, in one design, a meteorology tower (also referred to as a “met mast”) 42 monitors wind speed and direction from 4 levels above the ground, vertical wind speed, temperature, and pressure. The data is logged through a Campbell CR10X data logger 320, available from Campbell Scientific, Inc. of Logan, Utah. The data logger has a remote RS-232 serial communication interface through which sensor values in engineering units can be requested.

There will generally be multiple met masts and thus multiple loggers associated with each park.

Meteorology Tower Components and Interfaces

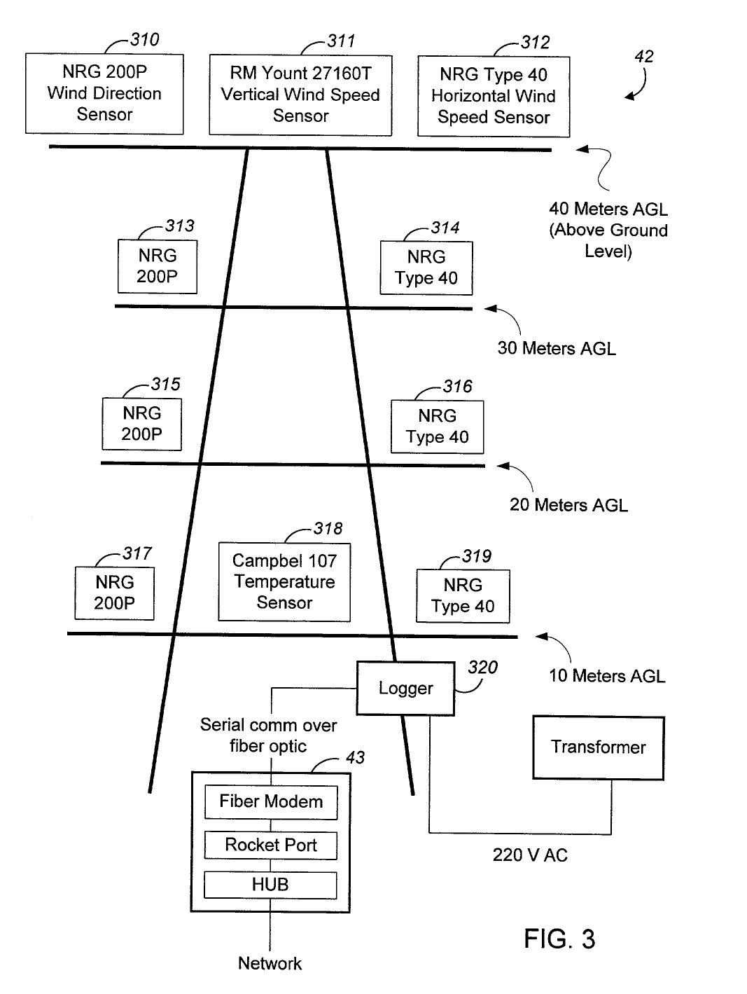

FIG. 4 illustrates the components and interfaces used for data collection on a met mast. The temperature sensor 318 is a Campbell 107 sensor. The pressure sensor 330 is a Vaisala PTB101B sensor. The vertical wind speed sensor 311 is a RM Young 27160T sensor. The horizontal wind direction sensors 310, 313, 315, 317 are NRG Type 200P sensors. The horizontal wind speed sensors 312, 314, 316, 319 are NRG Type 40 sensors. The met mast equipment also includes battery backup and charging components 340 and a fiber optic (FO) modem 350.

Met Mast Logging

All met mast data is time stamped with Julian day, year, hour, minute, and second.

The APU collects the following data for a met mast data screen of the TACS GUI in real time from the MPU: battery level, temperature, atmospheric pressure, four horizontal wind speeds, and four horizontal wind directions. These measurements are made available to the GUI through the database.

The APU also processes the raw data into the following summary data for a summary met mast data screen. These processed values are made available to the GUI through the database.

| | | | | Daily | 10 | 10 Minute |
|---|---|---|---|---|---|---|
| | Daily | Daily | Daily | Standard | Minute | Standard |
| Data Item | Max | Min | Average | Deviation | Average | Deviation |
| Battery level | X | X | X | X | | |
| temperature | X | X | X | X | | |
| atmospheric | X | X | X | X | | |
| pressure | | | | | | |
| vertical wind | X | X | X | X | | |
| speed | | | | | | |
| horizontal wind | X | X | X | X | | |
| speed | | | | | | |
| wind direction | | | | | X | X |

### Substation Processing Unit (SPU)

A Substation Processing Unit (SPU) is the on-site interface of the system to a substation. A substation 52 (FIG. 4) is the interface between the wind turbine power plant and the electrical grid. The SPU is implemented using a programmable logic controller (PLC) 54 that manages the substation interface.

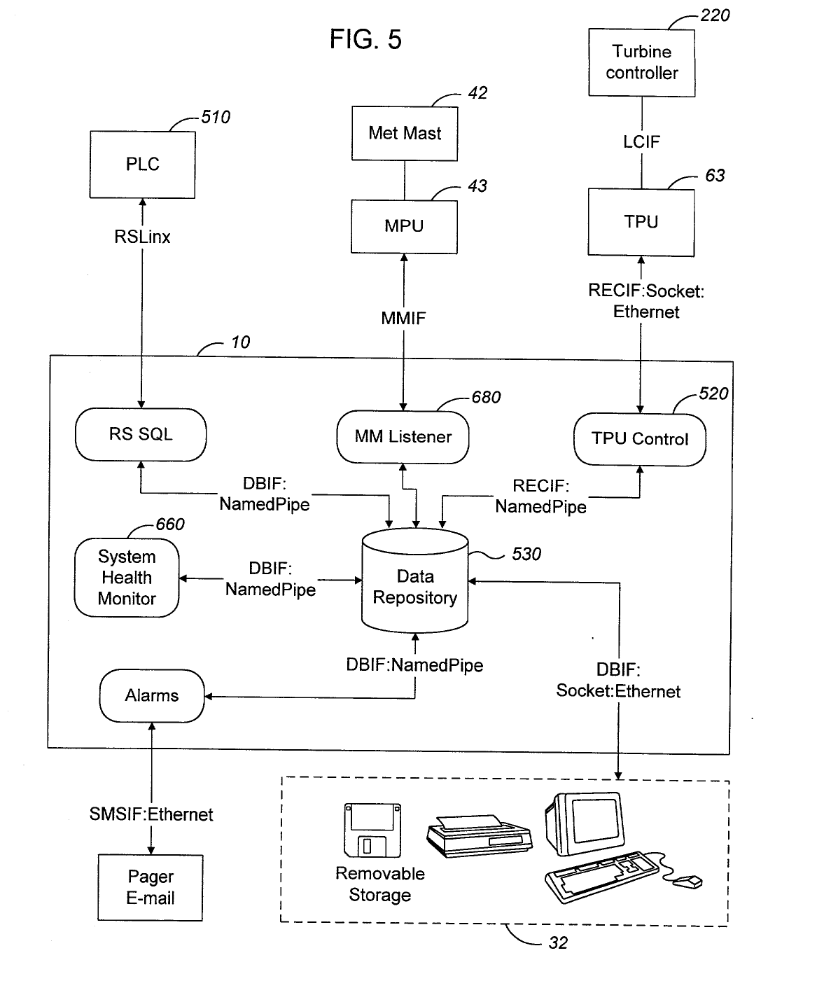

The PLC is an Allen-Bradley SLC 500 processor-based controller. The SLC 5/05 processor provides high bandwidth networking. As shown in FIG. 5, the PLC 510 is connected to the Server 10 over an Ethernet link using RSLinx as an interface driver and is programmed with the RSLogix tool. RSLogix 500 provides consolidated project view and drag-and-drop editing. (As shown in FIG. 1B, the server and the substation controller can be collocated at a substation site.) The modules for discrete inputs are sinking DC input modules, product number 1746-IB32; the analog I/O modules, product number 1746-NI8, and the digital output modules, product number 1746-OX8.

The IB-32 Module provides 32 digital sinking inputs, used with 24 VDC. It is organized into four groups, each with eight digital inputs and two commons. All commons are connected to the common measurement ground connection point. A +24 VDC signal present at the input indicates the input is in the active state.

The OX-8 Module provides eight fully isolated relay contact pairs, which can be used for digital output connection.

The NI-8 Module provides eight differential analog inputs which can be connected for differential or single-ended measurement. As configured in this system they are connected in a differential arrangement with the positive and negative input terminals connected to the respective positive and negative outputs of the sensors. Shielded cable is used for analog connections to minimized noise and ensure the greatest measurement accuracy.

The PLC program monitors the substation transformer and keeps the output within limits by controlling the transformer step adjustment.

The PLC program announces errors though memory tags containing the state of the alarm condition.

### The Array Communications Network (ACN)

The ACN 20 is the network component of the system. The network is a local area network based on Ethernet technology. The interconnections are generally based on optical fibers. The ACN is used to collect data from all network components, generally at the rate of at least once a minute. The ACN also provides a mechanism to configure, operate, and maintain the network components and to display configuration and operational status (such as communication errors and data rates) of all the network components. All control and monitoring equipment is interconnected by the network. In case of a network failure, each subsystem is expected to store its raw data locally for up to 48 hours.

### Interface Definitions

FIG. 5 is a block diagram of the principal subsystems and shows the names of the interfaces used.

The Database Interface (DBIF) is a standard interface that the TACS components use to communicate with the database. This interface consists of three parts: database language statements, function interface, and network protocol. The database language statements and function interface are encapsulated within a database application programming interface (API). The TACS database provides native database API support for Microsoft OLE DB and ODBC.

The TACS database allows client connection using three network protocols: named pipes, TCP/IP (Transmission Control Protocol/Internet Protocol) sockets, and multiprotocol. The Multiprotocol Net-Library uses the Windows remote procedure call (RPC) facility.

The Legacy Controller Interface (LCIF) controller protocol provides a generic turbine interface definition in order to support the future installations of TACS in sites where different turbine controllers are used.

The Campbell CR10X Logger supports a Campbell proprietary serial communication interface. This is recognized by the MM listener and used as a meteorological mast interface (MMIF).

The Substation Interface (SSIF) connects the Allen-Bradley Programmable Logic Controller (PLC) in a substation to the server. The SSIF communicates with the PLC using the Allen-Bradley RSLinx communication protocol over the Ethernet network.

Any remote subsystems can be connected through a generic remote equipment interface (RECIF) protocol to control and communicate with all of the TACS subsystems.

To support the notification of alarms to users of TACS, a short message service interface (SMSIF) provides an interface to a wireless Short Message Service to deliver pager or email messages.

### The APU (Continued)

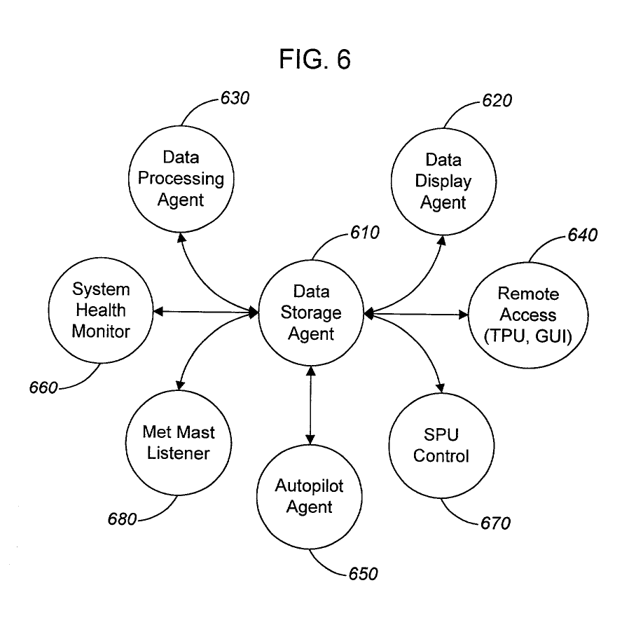

FIG. 6 shows the top-level architecture of the APU. The APU is implemented on a conventional computer server platform, such as a Dell™ PowerEdge 2300 computer. The server runs Microsoft Windows NT Server 4.0 with Service Pack 5 or later. Online disk memory is advantageously a RAID (Redundant Array of Inexpensive/Independent Disks) configuration with about 40 gigabytes of storage, estimating about 10 gigabytes to store the raw data for one month of operation.

The following paragraphs describe the software architecture of the APU. Data Storage Agent The Data Storage Agent 610 is the encapsulation of the data storage and data interface for TACS. The DBIF provides the TACS applications an Application Program Interface to access, store and update data in the databases.

The TACS database is implemented using Microsoft SQL (Structured Query Language) Server Version 7.0. The database supports remote communication through ODBC to the subsystems. The TACS database includes a configuration, an events, and a repository database, which will be described.

The current month's and last month's data are maintained online. At the end of each month, all of last month's data is archived and the current month's data becomes last month's data. Annual accumulated totals of production and other data are maintained and available throughout the year.

A Data Mapper class is provided to allow a common interface between TACS applications and the TACS database. The class provides a connection service and an add service to put data into the TACS repository database.

Microsoft SQL Server 7.0 utilities are used to manage the database. Generally, the databases are defined and instantiated upon installation of the system. The SQL Server incorporates services to manage the databases automatically and manually.

Data Display Agent

The Data Display Agent 620 supports interaction with TACS through the GUI, which can be accessed locally or remotely. Local access can be through a direct connection to the ACN or to an element of the system. Remote access 640 can be over a WAN (wide area network), including over the Internet, or through a telephonic connection, such as through a wireless link or a public switched telephone link. The user interface is organized in a tree structure and supports the drill down to any specific information the user may wish to view. The user interface supports multiple views to each subsystem to allow users access to real time data, summary data, alarms data, and subsystem controls.

The tree structure is displayed to give the user easy access to the components in the system. By double clicking on the icon representing a component in the tree, the window for the component is displayed in the main GUI window. The icons displayed in the tree display show the state of the related components, such as turbines and met masts. Each of the elements in the tree structure provides an interface to the window into the element. Each window contains a number of tabs to provide different views into the element.

The following tabs are typically available in the GUI window. Each can be selected to display a corresponding view, as described below.

| Tab Name | Description of View |
|---|---|
| Tabular | Raw data presented in tabular format |
| Graphical | A strip chart of raw data and bar chart of reduced data |
| Summary | Data reduced from raw data for real time data analysis |
| Control | Control interface to the element |
| Events | List of all the unacknowledged events from the element |
| Instrumented | Raw data presented in graphical format |

The GUI can provide a graphical view of the whole array, or of any park individually. This interface can provide an overview of the whole array at a glance.

Data Processing Agent (DPA)

The Data Processing Agent (DPA) 630 is implemented as a generic NT service that periodically makes one or more decisions by evaluating data in the database.

The configuration details for each DPA decision are saved as a DPA rule in the configuration database. Each DPA rule has an enable flag, description, evaluation group, evaluation procedure (stored procedure) name, and optional action fields. If the enable flag for a particular DPA rule is zero, then that DPA rule is not evaluated during processing. If the enable flag is set to ‘1’, then it is enabled for evaluation.

Each DPA rule also belongs to a class. The class distinction allows the DPA additional execution flexibility in the implementation of the processing engine.

The DPA wakes up once a second and queries the database for evaluation groups. Each evaluation group has an evaluation period that is compared against the current system time to determine whether the group should be processed at the current time.

When an evaluation group is processed, the DPA queries the database for all DPA rules belonging to the group. Then, the evaluation procedure for each DPA rule belonging to the group is executed. If the DPA rule evaluation returns a result set (the result of a SELECT statement in the stored procedure), the DPA checks whether the rule has an action procedure to execute. If so, the DPA executes the specified action procedure with zero or more parameter values from the corresponding evaluation result set. This allows field values from the result set to be passed to the action procedure.

Each DPA rule contains the configurable fields described in the table below. If the configuration for a parameter is NULL, then the DPA will not include that parameter when executing the action stored procedure.

| FIELD | DESCRIPTION |
|---|---|
| Evaluation_proc_{—} | The name of the evaluation stored procedure |
| name | |
| has_action | Set true if this DPA rule has an action to process. |
| | Otherwise, set false. |
| action_proc_name | The name of the action stored procedure |
| action_param_1 | If not NULL and has_action is true, this string is |
| | passed as the first parameter when the action_{—} |
| | proc_name stored procedure is called. |
| action_param_2 | If not NULL and has_action is true, this string is |
| | passed as the second parameter when the action_{—} |
| | proc_name stored procedure is called. |
| action_param_3 | If not NULL and has_action is true, this string is |
| | passed as the third parameter when the action_{—} |
| | proc_name stored procedure is called. |
| action_param_4_{—} | If not NULL and has_action is true, this string is |
| fieldkey | used to look up a value in the result set which will |
| | be passed as the fourth parameter when the action_{—} |
| | proc_name stored procedure is called. |
| action_param_5_{—} | If both fields are not NULL and has_action is true |
| special | then these fields create the fifth parameter to be |
| action_param_5_{—} | passed when the action_proc_name stored |
| fieldkey | procedure is called. |
| action_param_6_{—} | If both fields are not NULL and has_action is true |
| special | then these fields create the sixth parameter to be |
| action_param_6_{—} | passed when the action_proc_name stored |
| fieldkey | procedure is called. |

The evaluation stored procedure may contain any valid combination of SQL commands, although if multiple result sets are returned, the DPA will only review the first data set.

The action stored procedure may contain any valid combination of SQL commands.

The DPA has two methods of reporting error conditions. Problems executing an evaluation procedure or action procedure are saved as an event record in the events database. Initialization or operational problems with the DPA service are stored in the NT event log.

The DPA is used to implement the following three main functional components of TACS: automatic power control, post processing, and event processing.

Autopilot Agent

It is at times necessary to limit the power output of the wind power system; for example, the utility company may need to work on power lines. The Autopilot Agent 650 is notified when it is necessary to increase or decrease a line power level. The Autopilot Agent monitors the power level and queues a turbine control command when necessary. The Autopilot Agent determines which turbine should be turned off to decrease the power level or which turbine to turn on to increase the power level.

An authorized user can enter Autopilot rules through the GUI. For example, a user can enter the Autopilot time range, power limits, and a short description through the GUI. When an operator deletes an existing automatic control record, the GUI will execute a stored procedure to delete the record. This stored procedure is in the configuration database.

When the operator adds a new automatic control record or edits an existing record, a pop-up dialog box is displayed. Pressing the OK button will cause the GUI to execute a stored procedure to add or edit the record. These stored procedures are in the configuration database.

The table below describes how the DPA rule action parameters are configured to implement the Autopilot Agent.

| FIELD | DESCRIPTION |
|---|---|
| Evaluation_proc_name | dpa_rule_autopilot_evaluation - The name of the stored |
| | procedure to evaluate all autopilot records. |
| has_action | 1 - which indicates it has an action to process. |
| action_proc_name | dpa_action_autopilot_control - The name of the stored |
| | procedure to perform the autopilot action for all autopilot |
| | records. |
| action_param_1 | Minimum power limit in Watts |
| action_param_2 | Maximum power limit in Watts |
| action_param_3 | Time range, start time in UTC seconds |
| action_param_4_fieldkey | main_active_power - This column value is read from the |
| | result set and passed as the fourth parameter to the action |
| | procedure. Since the evaluation procedure selects from |
| | the substation_latest table, this will get the latest real |
| | power value and pass it to the action procedure. |
| action_param_5_special | Time range, end time in UTC seconds |
| action_param_5_fieldkey | NULL |
| action_param_6_special | NULL |
| action_param_6_fieldkey | time_stamp - returns the current UTC time to the action |
| | procedure. |

The stored procedure dpa_rule_autopilot_evaluation determines, at regular intervals such as every 30 seconds whether there is an autopilot record to process. If there is and if (i) the current time is within the time range specification and the total power is outside the maximum or minimum power limits, then the dpa_action_autopilot_control stored procedure is performed. This procedure finds a turbine to shut down if total power exceeds the maximum or finds a turbine to turn on if total power is less than the minimum. Such a turbine must be under auto control. If such a turbine is found, a command to the turbine is enqueued and an information event is created. If no such turbine is found to turn off, a critical event is created.

Additional functionality for the Autopilot Agent is encapsulated in the stored procedure dpa rule_autopilot maintenance, which is periodically executed. This procedure looks for autopilot control commands that have timed out and creates an event. It also looks for turbines that have been manually controlled by an operator and removes these turbines from control by the autopilot.

Post Processing Agent

The Post Processing Agent periodically processes the raw data collected from system components and stores the reduced data in the summary data tables for the GUI summary screens. This agent also implements other periodic system functionality such as subsystem communication failure detection and event creation.

The table below describes how the DPA rule action parameters are configured to implement the post processing data reduction agent.

| FIELD | DESCRIPTION |
|---|---|
| Evaluation_proc_name | Contains the name of the stored procedure that |
| | will perform the desired data processing. The |
| | stored procedure should be located in the |
| | repository database. The name should follow |
| | the convention ‘dpa_rule_nnnnn_xx..’ |
| | where ‘nnnnn’ is the associated DPA rule |
| | key identifier and ‘xx..’ describes the |
| | effect of this post processing operation. |
| has_action | 0 - which indicates it has no action |
| All remaining fields -- | NULL |

The specific functionality for each data reduction is encapsulated in the corresponding evaluation stored procedure for that DPA rule. Note that the action fields are not used for the data reduction agent.

The table below describes the evaluation stored procedures used by the data reduction agent.

| DPA Rule | Evaluation Procedure Name | Description |
|---|---|---|
| 1000 | dpa_rule_turbine_cmd_cleaner | Detects stale turbine control commands |
| 1010 | dpa_rule_autopilot_maintenance | Detects problems with automatic |
| | | control of turbines |
| 1020 | dpa_rule_tpu_command_bridge | Handles processing of operator manual |
| | | control commands from the GUI |
| 1030 | dpa_rule_01030_sub_comm_fail | Detects communication failure with |
| | | the substation data collection |
| 1040 | dpa_rule_01040_met_comm_fail | Detects communication failure with |
| | | the meteorological mast data collection |
| 1090 | dpa_rule_post_time | Posts the current time for SQL access |
| 10001 | dpa_rule_10001_turbine_summary | Creates summary data for turbines |
| 10002 | dpa_rule_10002_mets_env_tabular | Creates environmental summary data |
| | | over all meteorological sites |
| 10003 | dpa_rule_10003_mets_wind_tabular | Creates wind summary data over all |
| | | meteorological sites |
| 10004 | dpa_rule_10004_mets_summary | Creates summary data for all |
| | | meteorological sites |
| 10005 | dpa_rule_10005_one_met_summary | Creates summary data for each |
| | | meteorological site |
| 10010 | dpa_rule_10010_turbine_comm | Detects communication failure with |
| | | the turbine data collection |
| 10020 | dpa_rule_10020_spain_summary | Creates summary data for all parks in |
| | | an aggregation called Spain |
| 10100 | dpa_rule_10100_park_summary | Creates summary data for the parks |
| 10101 | dpa_rule_10101_park_tabular | Creates summary data for the parks |
| | | tabular window in the GUI |
| 11000 | dpa_rule_11000_10MIN_data | Creates summary data for 10 minute |
| | | values |
| 12000 | dpa_rule_12000_turbine_availability | Creates summary data of turbine |
| | | availability |

Event Notification Agent

The Event Notification Agent is responsible for notifying operators of TACS events. Events may be informational, warning, or critical. Critical events are alarm conditions in the system. This agent detects the specific event condition, adds an event record in the log, and notifies operators of the event.

A TACS system administrator can configure event criteria using the TACS configuration console. The event criteria include specification of comparison operands, comparison operator, evaluation group, event description, and alerting information. The GUI adds, edits, or deletes event configuration records by executing the respective stored procedure sp_dpa_add_event_record, sp_edit_event_record, or sp_delete_event_record in the configuration database.

The table below describes how the action parameters are configured in the DPA rules to implement the event processing agent.

| Field | Description |
|---|---|
| evaluation_proc_name | Contains the name of the stored procedure for this event |
| | notification. The stored procedure is in the repository |
| | database. The name follows the convention |
| | ‘dpa_rule_20nnn_event_detection’, where ‘nnn’ is the |
| | associated DPA rule key identifier (between 20000 and |
| | 20999. |
| has_{—action} | 1 - which indicates it has an action to process |
| action_proc_name | Contains the name of the stored procedure that will be |
| | executed if this event is detected. For the configurable |
| | events the stored procedure is |
| | ‘dpa_action_20000_event_notify’. |
| action_param_1 | The DPA rule number; used as the event identifier number |
| | in the event log |
| action_param_2 | The event level for the event log: 1 = informational, |
| | 2 = warning, 3 = critical |
| action_param_3 | The event source category for the event log: 2 = TPU, |
| | 3 = meteorological site, 4 = Substation |
| action_param_4_fieldkey | The column name (corresponding to the evaluation |
| | procedure SELECT table) to return the event source number |
| | for the event Jog. |
| action_param_5_special | A short description of the event for alerting |
| action_param_5_fieldkey | field name - The column name of a field value to include in |
| | the event description |
| action_param_6_special | The alerting string: If NULL then alerting is disabled. If |
| | exists then it is included in the alerting record. This string |
| | contains the alerting group information |
| action_param_6_fieldkey | NULL |

System Health Monitor

The System Health Monitor 660 is responsible for collecting and evaluating events that are related to the status of the system health and reporting the results to the events database. The System Health Monitor also checks the subsystems and reports when there is a failure to respond.

Remote Access

The APU provides remote access 640 for the TPUs and the GUI. The TPU Control Agent 520 (FIG. 5) receives messages that are sent to the TPU through the RECIF interface. Control messages are sent from the Autopilot thread of the DPA 630 and from the user through the GUI.

Substation Processing Unit Control

The Substation Processing Unit (SPU) Control 670 process continually monitors the substation for discrete and analog inputs. The SPU Control also manages the discrete outputs set through the GUI or otherwise.

The SPU Control is implemented using the Rockwell Software's RSSql and RSLinx software packages. RSSql is responsible for interfacing with the Allen-Bradley PLC (which manages the substation interface) through RSLinx. This process collects data samples from the substation and stores them in the substation data tables of the TACS database. The PLC program converts all of the analog inputs to the correct engineering units before storing them in the memory tag to be read by the server.

RSSql also monitors the database for requests to pulse substation discrete control outputs. When a record is inserted into the substation control table, RSSql reads the output command then sets the PLC output command symbol. After the command has been sent to the PLC the command record is removed from the database. The PLC reads the command output in the output command symbol then holds the corresponding discrete output line closed as required. Then the PLC clears the output command symbol value.

Met Mast Listener

The Met Mast Listener process (MMListener) 680 collects the raw data from the met mast data loggers. Once the data is collected from a logger, the Met Mast Listener uses the TACS Data Mapper interface to connect to the TACS databases and store the data in the TACS repository database.

If communication with the met mast is lost and the raw data is not available for sampling, the logger will continue to collect the raw data and reduce the values into the data required for any mandatory data reductions. The reduced data can be accessed from the logger locally or through the network when communication is restored. The data can be retrieved with the Campbell Scientific PC208W tool.

The MMListener is implemented as an NT Service dependent on the SQL Server Service. The service reads the TACS SQL configuration database and determines if there are any meteorological towers. A worker thread is started for each of the met masts. The worker threads are set up to run once a second. On startup, the treads open a connection to the database and the communication port for the met mast. Then, synchronized communication with the logger is established. Any failure creates an alarm condition.

The worker thread is responsible for requesting the raw input sensor data from the logger. The data is sampled in two sets because there is a different update rate for each of the sets of data. The first set of data is the wind data. This data is collected once a second from the 8 horizontal wind sensors and the 1 vertical wind sensor. The second set of data is the environment data. This data is collected once every 30 seconds from the atmospheric pressure, temperature and battery level sensors.

### Database Schema

The TACS database 530 (FIG. 5) includes a configuration database, an events database, and a repository database.

The configuration database contains the data associated with the current configuration of the system. This includes names and identities of all the TPUs, met masts, and substations in the system. The current Data Processing Rules and Alarm Configuration are also stored here.

The events database contains records of the events that have occurred in the system. Some of the events are alarms; some, simply informational. The tables include occurrence time and message, acknowledgement time and message, and closure time and message.

The repository database contains all of the raw data samples collected from the TPUs, met masts and substations. This raw data is available for post processing and data analysis. To save data storage space, data that can be reduced from the raw data is only updated in tables to make the data available to the GUI. Some of the raw data is also stored in updated tables with the same data so that the GUI can access data tables with very few records.

### Repository Database

TABLE turbine_latest

A record is updated in the turbine_latest database table each second by each TPU. The source of the data is the TPU, except as noted. This table contains the latest value of the turbine data samples. The data in this table is used in the GUI turbine window tabular view.

| Field | Description | History |
|---|---|---|
| turbine_number | TPU database identifier number | ✓ |
| time_stamp | Time Stamp. Here and elsewhere, time is in seconds | ✓ |
| | since midnight, January 1, 1970, coordinated | |
| | universal time (UTC) or Greenwich mean time | |
| | (GMT). | |
| operational_status | Operational State. A code for one of: running OK; | ✓ |
| | fault; no communication (set by DPA if | |
| | communication fails); offline; available; not ready. | |
| turbine_status | Turbine Status. A code for one of: fault; off; too | ✓ |
| | much wind; cables twisted (left or right); manually | |
| | starting; automatically starting; not yawed; start at | |
| | wind limit; control time before start; enough wind; | |
| | too little wind | |
| brake_status | Brake Status. A code for one of: brake pulled; not | ✓ |
| | enough pressure; brake released. | |
| generator_status | Generator Status. A code for one of: large generator | ✓ |
| | cutting in; small generator cutting in; motor start on | |
| | generator; no motor start for 7.5 minutes; generator | |
| | inactive. | |
| generator_rpm | Generator RPM | ✓ |
| generator_1_temp | Generator 1 Temperature | ✓ |
| generator_2_temp | Generator 2 Temperature | ✓ |
| gearbox_temp | Gearbox Temperature | ✓ |
| ambient_temp | Ambient Temperature | ✓ |
| wind_speed | Wind Speed | ✓ |
| grid_freq | Grid Frequency | ✓ |
| rotor_rpm | Rotor RPM | ✓ |
| Yaw | Yaw | ✓ |
| wind_direction | Wind Direction. Calculated from turbine yaw value | |
| | in database | |
| real_power | Real Power (KW) | ✓ |
| reactive_power | Reactive Power (KVar) | ✓ |
| power_factor | Power Factor | ✓ |
| phase_r_voltage | Phase R Voltage | ✓ |
| phase_s_voltage | Phase S Voltage | ✓ |
| phase_t_voltage | Phase T Voltage | ✓ |
| phase_r_current | Phase R Current | ✓ |
| phase_s_current | Phase S Current | ✓ |
| phase_t_current | Phase T Current | ✓ |
| gen_1_energy_tt1 | Generator 1 Energy Total (KWh) | |
| gen_2_energy_ttl | Generator 2 Energy Total (KWh) | |
| gen_1_prod_time_tt1 | Generator 1 Production Time Total (Hours) | |
| gen_2_prod_time_tt1 | Generator 2 Production Time Total (Hours) | |
| safety_switch | Safety Switch: remote or local. | ✓ |
| operation_code | Turbine Operational Code. A code for one of: | |
| | normal operation; operational stop with automatic | |
| | start; motor start cut out due to fault; small generator | |
| | cut out due to fault; stopped for manual start; stopped | |
| | - must be restarted; free wheeling - must be restarted | |
| | by reset. | |

TABLE turbine_history

A record is added to the turbine_history database table each second by each TPU. This table contains a history of the turbine data samples. The fields of this table are identified by a check mark in the description of the turbine_latest database table, above.

TABLE turbine_summary

This database table contains one record for each TPU. All records in this table are updated once a second (unless stated otherwise) by the DPA. The data in this table is used in the GUI turbine window summary view.

| Field | Description |
|---|---|
| turbine_number | (a blank description means that a previously-given description |
| | applies.) |
| time_stamp | |
| operational_status | Operational State, from turbine_latest table |
| avg_prod_parker | Average Production over 10 minutes (KW). Here and elsewhere, |
| | production is calculated according to the measurement algorithm |
| | from IEC 61400-12:1998(E) Wind turbine generator systems - |
| | Part 12: Wind turbine power performance testing (“Parker”). |
| expected_prod_parker | Expected Production over 10 minutes (KW) |
| production_efficiency | Production Efficiency. This is 100% times avg_prod_parker |
| | divided by expected_prod_parker |
| availability_per_hour | Availability per Hour. This value is calculated once a minute (as |
| | a percent) using the previous 3600 samples of the |
| | operational_status. |
| number_of_alarms | Number of active unacknowledged alarm records for this turbine |

TABLE turbine_control_requests

This database table contains the queue for TPU control requests from the GUI. A request record can be inserted into the database table by the GUI or other system device. The DPA examines this database table once a second to process waiting command requests. When the DPA reads the record, it also deletes the record.

| Field | Source | Description |
|---|---|---|
| turbine_number | GUI | TPU database identifier number |
| transaction_number | SQL | Request Transaction Number. A transaction number is |
| | | added by the SQL server when a record is inserted in |
| | | the substation_control_queue. |
| command_str | GUI | Command String. A code representing one of: manual |
| | | start request; manual stop request; manual reset |
| | | request. |

TABLE turbine_control

This database table contains the queue for TPU control requests. A request record may be inserted into this table by the DPA in response to a request record being inserted in the turbine_control_requests table. Each TPU examines this table once a second to see if a control record is waiting. When the TPU reads the record from the table it also deletes the record indicating that the control request has been received.

| Field | Source | Description |
|---|---|---|
| turbine_number | DPA | TPU database identifier number |
| transaction_number | SQL | Request Transaction Number, as above |
| command_str | DPA | Command String, either 1=start or 2=stop |
| time_stamp | DPA | Time command was inserted into this |
| | | queue |

TABLE turbine_autocontrol

This database table contains one record for each turbine in the system. Turbines that are allowed to be automatically controlled by autopilot will have their autopilot enabled field set by the GUI. If an operator manually controls a turbine through the GUI, the turbine is removed from automatic control.

| Field | Source | Description |
|---|---|---|
| turbine_number | | TPU database identifier number |
| autopilot_enabled | DPA, GUI | Autopilot Enabled Status |
| autopilot_shutdown | DPA | Autopilot State |
| shutdown_count | DPA | Number of times this turbine has been |
| | | shut off by autopilot. Incremented |
| | | each time turbine is automatically shut |
| | | off by autopilot. This counter is |
| | | used by autopilot algorithm to |
| | | determine which turbine to shut off. |

TABLE turbine_comm_latest

This database table contains one record for each turbine in the system. The source is the DPA. The comm_failure field specifies the latest communication status for the respective turbine.

| Field | Description |
|---|---|
| turbine_number | |
| time_stamp | |
| comm_failure | Communication status |

TABLE turbine_comm_history

A new record is inserted in this database table each time the communication status changes for each turbine.

| | |
|---|---|
| Field | Description |

turbine_number
time_stamp
comm_failure

TABLE WTG10MIN

This database table contains 10 minute summaries of the wind turbine data. A new record is inserted in this database table for each turbine every 10 minutes if at least one sample record is found for this turbine.

| Field | Description |
|---|---|
| time_stamp | |
| Wdate | Date String (DD/MM/YYYY) |
| Wtime | Time String (24 hour) |
| wtg_id | Turbine Number |
| circuit_id | Circuit Identifier. This corresponds to the |
| | park number for the turbine and may be |
| | found in the park_configuration table. |
| wind_speed | Wind Speed. Mean value over the last 10 |
| | minute for turbine wind speed (from |
| | turbine_history.wind_speed). |
| Power | Power. Mean value over the last 10 minute |
| | for turbine power (from |
| | turbine_history.real_power) |
| status_fault | Turbine Fault. Set to 1 if the turbine had a |
| | fault during the previous 10 minutes (from |
| | turbine_history.operation_status) |
| status_offline | Turbine Offline. Set to 1 if the turbine |
| | was offline during the previous 10 |
| | minutes (from |
| | turbine_history.operational_status) |
| status_running | Turbine Running. Set to 1 if the turbine |
| | was running during the previous |
| | 10 minutes (from |
| | turbine_history.operational_status) |
| status_communication_error | Communication Error. Set to 1 if the |
| | turbine had a communication error during |
| | the previous 10 minutes (from |
| | turbine_history.operational_status) |
| status_autopilot | Autopilot Enabled. Set to 1 when |
| | the turbine was shutdown by autopilot |
| | during the previous 10 minutes (from |
| | turbine_history.operational_status, and |
| | turbine_autocontrol table) |
| downtime_category | Downtime Category |
| Communications | Complete Communication Failure. Set to 1 |
| | if the turbine had no successful |
| | communication during the previous 10 |
| | minutes (from |
| | turbine_history.operational_status) |
| Events | Communication Failure Overload. Set to 1 |
| | if the turbine had communication |
| | failures when the previous 10 |
| | minutes started (from |
| | turbine_history.operational_status) |

TABLE turbine_control

The turbine_control database table contains one record for each turbine. All records in this table are updated once a second by the DPA. The data in this table is used in the GUI turbine window control view. When the GUI changes a field in this table for a particular turbine, the DPA detects the change and send the control information to the TPU.

| Field | Description |
|---|---|
| turbine_number | There is one record in this table for each turbine |
| time_stamp | Sample time stamp, as above |
| turbine_controller_on | on ON/OFF |
| turbine_reset | Set to TRUE to initiate a reset. The TPU |
| | controller sets FALSE after reset. |
| yaw_cw | ON/OFF |
| yaw_cw | ON/OFF |

TABLE park_tabular

The park_tabular database table contains one record for each park. All records in this table are updated once a second by the DPA. The data in this table is used in the GUI park window tabular view.

| Field | Description |
|---|---|
| park_number | Park database identifier number |
| time_stamp | |
| operational_status | Number of TPUs in this park with |
| | operational_status of “Running |
| | OK” at this instant |
| turbine_status | Number of TPUs in this park with |
| | turbine_status of “Enough |
| | Wind (OK)” at this instant |
| generator_status | Number of TPUs in this park with |
| | generator_status of “Large |
| | Generator cut in” at this instant |
| avg_generator_rpm | Simple average of all generator_rpm values |
| | (excluding zero values) for the TPUs in this |
| | park at this instant |
| avg_ambient_temp | Simple average of all ambient_temp values |
| | for the TPUs in this park at this instant |
| avg_wind_speed | Simple average of all wind_speed values |
| | for the TPUs in this park at this instant |
| avg_rotor_rpm | Simple average of all rotor_rpm values |
| | (excluding zero values) for |
| | the TPUs in this park at this instant |
| total_real_power | Sum of the real_power values for all |
| | turbines in this park at this instant |
| total_reactive_power | Sum of the reactive_power values for all |
| | turbines in this park at this instant |
| power_factor | Power Factor. Calculated as total_real_power |
| | divided by the square root of the sum of the |
| | squares of total_real_power and |
| | total_reactive_power. |
| total_phase_r_voltage | Total Phase R Voltage. These totals are simple |
| | averages of all phase_x_voltage values |
| | for the TPUs in this park at this instant |
| | (for x = r, s, or t) |
| total_phase_s_voltage | Total Phase S Voltage |
| total_phase_t_voltage | Total Phase T Voltage |
| total_phase_r_current | Total Phase R Current. Sum of all |
| | phase_r_current values for the |
| | TPUs in this park at this instant. |
| total_phase_s_current | Total Phase S Current |
| total_phase_t_current | Total Phase T Current |

TABLE park_summary

The park_summary database table contains a record for each park. All records in this table are updated once a second (unless otherwise stated) by the DPA. The data in this table is used in the GUI park window summary view.

| Field | Description |
|---|---|
| park_number | |
| time_stamp | |
| avg_prod_parker | Avg. Production over 10 min. (KW) for all |
| | turbines in this park |
| expected_prod_parker | Expected Production over 10 min. (KW) |
| production_efficiency | Production Efficiency |
| number_of_alarms | Number of active unacknowledged |
| | alarm records for this park |
| availability_per_hour | Simple average of the availability_per_hour |
| | values for all of the turbines in this park |
| energy_per_10 min | Energy over 10 minutes (KWH) for all turbines |
| | in this park. This is part of the measurement |
| | algorithm from IEC 61400-12:1998(E). |

TABLE met_environment_history

The met_environment database table has a record is added to it each minute from each Meteorological Processing Unit (MPU). This table contains a history of the meteorological environment data samples. The database also includes an identical table met_environment_latest, which is updated each minute with the latest meteorological values. The source of the data is the MPU. The data in the met_environment_latest table is used in the GUI Meteorological site window tabular view.

| Field | Description |
|---|---|
| met_site_number | Meteorological site database identifier number |
| time_stamp | |
| battery_level | Battery level (volts) |
| ambient_temp | Ambient temperature (0° C.) |
| atmospheric_pressure | Atmospheric pressure (millibars) |

TABLE met_wind_history

The met_wind_history database table has a record added to it each second by each MPU. This table contains a history of the meteorological wind data samples. The database also includes an identical table called met_wind_latest, which is updated each second with the latest meteorological values. The source of the data is the MPU. The data in the met_wind_latest table is used in the GUI Meteorological site window tabular view.

| Field | Description |
|---|---|
| met_site_number | |
| time_stamp | |
| vert_wind_speed | Vertical wind speed (m/s) |
| horz_40m_wind_speed | Horizontal wind speed at 40 meters (m/s) |
| | (always above ground level) |
| horz_30m_wind_speed | Horizontal wind speed at 30 meters (m/s) |
| horz_20m_wind_speed | Horizontal wind speed at 20 meters (m/s) |
| horz_10m_wind_speed | Horizontal Wind Speed at 10 meters (m/s) |
| wind_direction_40m | Wind Direction at 40 meters |
| wind_direction_30m | Wind Direction at 30 meters |
| wind_direction_20m | Wind Direction at 20 meters |
| wind_direction_10m | Wind Direction at 10 meters |

TABLE met_summary

The met_summary database table contains a record for each MPU. This table is updated once a minute. The source of the data is the DPA. The data in this table is used in the GUI Meteorological site window summary view.

| Field | Description |
|---|---|
| met_site_number | |
| time_stamp | |
| min_battery_level | Daily minimum battery level (volts) |
| avg_battery_level | Daily average battery level (volts) |
| stdv_battery_level | Daily standard deviation battery level |
| | (volts) |
| min_ambient_temp | Daily minimum temperature (° C.) |
| max_ambient_temp | Daily maximum temperature (° C.) |
| avg_ambient_temp | Daily average temperature (° C.) |
| stdv_ambient_temp | Daily standard deviation temperature |
| | (° C.) |
| min_atmospheric_pressure | Daily minimum atmospheric pressure (mb) |
| max_atmospheric_pressure | Daily minimum atmospheric pressure (mb) |
| avg_atmospheric_pressure | Daily average atmospheric pressure (mb) |
| stdv_atmospheric_pressure | Daily standard deviation atmospheric |
| | pressure (mb) |
| min_vert_wind_speed | Daily minimum vertical wind speed (m/s) |
| max_vert_wind_speed | Daily maximum vertical wind speed (m/s |
| avg_vert_wind_speed | Daily average vertical wind speed (m/s) |
| stdv_vert_wind_speed | Daily standard deviation vertical wind |
| | speed (m/s) |
| min_horz_wind_speed | Daily minimum horizontal wind speed |
| | (m/s) |
| max_horz_wind_speed | Daily Max. horizontal wind speed |
| | (m/s) |
| avg_horz_wind_speed | Daily average horizontal wind speed (m/s) |
| stdv_horz_wind_speed | Daily standard deviation horizontal wind |
| | speed (m/s) |
| avg_wind_direction | 10 min average wind direction from |
| | the MPU |
| stdv_wind_direction | 10 min standard deviation wind direction |

TABLE mets_environment_tabular

The mets_environment_tabular database table contains one record for the meteorological overview. This record is updated once a minute by the DPA. The data in this table is used in the GUI Meteorological overview window tabular view.

| Field | Description |
|---|---|
| met_cluster_number | Meteorological cluster database identifier |
| | number |
| time_stamp | |
| avg_battery_level | Simple average of the battery_level from all |
| | meteorological sites in this cluster |
| avg_ambient_temp | Simple average of the ambient_temp |
| | from all meteorological sites in this cluster |
| avg_atmospheric_pressure | Simple average of the atmospheric_pressure |
| | from all meteorological sites in this cluster |

TABLE mets_wind_tabular

The mets_wind_tabular database table contains one record for the meteorological overview. This record will be updated once a second by the DPA. The data in this table is used in the GUI Meteorological overview window tabular view.

| Field | Description |
|---|---|
| met_cluster_number | |
| avg_time_stamp | Time stamp |
| avg_vert_wind_speed | Simple average of vert_wind_speed |
| | from all meteorological sites in this cluster |
| avg_horz_40m_wind_speed | Simple average of |
| | horz_40m_wind_speed |
| | from all meteorological sites in this cluster |
| avg_horz_30m_wind_speed | Simple average of |
| | horz_30m_wind_speed from |
| | all meteorological sites in this cluster |
| avg_horz_20m_wind_speed | Simple average of |
| | horz_20m_wind_speed from |
| | all meteorological sites in this cluster |
| avg_horz_10m_wind_speed | Simple average of |
| | horz_10m_wind_speed from |
| | all meteorological sites in this cluster |
| avg_40m_wind_direction | Simple average of 40m_wind_direction |
| | from all meteorological sites in this cluster |
| avg_30m_wind_direction | Simple average of 30m_wind_direction |
| | from all meteorological sites in this cluster |
| avg_20m_wind_direction | Simple average of 20m_wind_direction |
| | from all meteorological sites in this cluster |
| avg_10m_wind_direction | Simple average of 10m_wind_direction |
| | from all meteorological sites in this cluster |

TABLE mets_summary

The mets_summary database table contains one record for the meteorological overview. This record is updated once a minute by the DPA. The source of the data is the DPA. The data in this table is used in the GUI Meteorological overview window summary view.

The fields in this table have the same names as those in the met_summary table, described above. In the mets_summary table, the minima, maxima, averages, and standard deviations are taken over all the sites in the cluster. The minima and maxima are reset at midnight.

TABLE substation_latest

A substation record is updated in the substation_latest database table each second by the substation PLC. The data in the substation latest table is used in the GUI Substation window tabular view.

The substation record includes substation_number (the substation identifier number) and time stamp fields. The record also includes fields for all of the data acquired by the PLC, including both discrete state data and analog measurements. These include the open or closed states of circuit breakers, the charge states of capacitor banks, the settings of transformer regulators, and the currents and voltages at particular points in the substation. In particular, it includes measurements of active power, reactive power, and calculations of the corresponding power factor for power supplied by the substation.

TABLE substation_history

A record is added to the substation_history database table each second by the substation PLC. The data in the substation_latest table is used in the GUI Substation window tabular view. The fields are those of the substation_latest table other than the calculated power factor fields.

TABLE substation_fault_history

The substation_fault_history database table contains one record for each substation. The record is updated each second by the substation PLC. The field values are a substation number, a time stamp, and Boolean values indicating the presence or absence of each of the possible alarm conditions, which are used to generate alarm records.

TABLE substation_summary

The substation_summary database table contains one record for each substation. The record is updated each second by the DPA or by the RSSql agent. The data source is the substation PLC. This table is used in the GUI Substation window summary view.

| Field | Description |
|---|---|
| substation_number | |
| time_stamp | |
| main_active_energy_out | Total active energy out from the substation |
| main_reactive_energy_{—} | Total reactive energy out from the substation |
| out | |
| main_active_energy_in | Total active energy into the substation |
| main_reactive_energy_in | Total reactive energy into the substation |
| cn_active_energy_in | Circuit n active energy in to substation |
| | circuit n (one field for each substation |
| | circuit, which may, for example, correspond |
| | to a park) |
| cn_active_energy_out | Circuit n active energy out |
| cn_reactive_energy_in | Circuit n reactive energy in |
| cn_reactive_energy_out | Circuit n reactive energy |
| | out |

TABLE substation_control

The substation_control database table contains the queue for substation control requests. A request record may be inserted into the table by the GUI, DPA, or other system component. The substation examines this table once a second to see if a control record is waiting. When the RSSql agent reads the record from the table, it deletes the record, indicating that the control request has been received. The RSSql agent then forwards the request to the PLC at the substation providing the required signaling.

| Field | Source | Description |
|---|---|---|
| Substation_number | GUI | Substation identifier number |
| Transaction_number | SQL | Request Transaction Number |
| Command_str | GUI | Command String |

The values for the command_str field are defined for, and interpreted by, the particular PLC as installed at the substation.

TABLE system_summary

The system_summary database table contains one record. The fields are updated once a second (unless otherwise noted) by the DPA. The data in this table is used in the GUI system window summary view.

| Field | Description |
|---|---|
| time_stamp | |
| operational_status | Number of TPUs in all parks with operational_{—} |
| | status of “OK” at this instant |
| turbine_status | Number of TPUs in all parks with turbine_{—} |
| | status of “OK” at this instant |
| generator_status | Number of TPUs in all parks with generator_{—} |
| | status of “OK” at this instant |
| avg_generator_rpm | Simple average of all generator_rpm values |
| | for the TPUs in all parks at this instant |
| avg_ambient_temp | Simple average of all ambient_temp values for |
| | the TPUs in all parks at this instant |
| avg_wind_speed | Simple average of all wind_speed values for |
| | the TPUs in all parks at this instant |
| avg_rotor_rpm | Simple average of all rotor_rpm values for |
| | the TPUs in all parks at this instant |
| total_real_power | Sum of all total_real_power values in |
| | all parks at this instant (KW) |
| total_reactive_power | Sum of all total_reactive_power values in all |
| | parks at this instant (KVar) |
| power_factor | Power Factor for total_real_power and |
| | total_reactive_power |
| avg_prod_parker | Average Production over 10 min. (KW) |
| expected_prod_parker | Expected Production over 10 min. (KW) |
| production_efficiency | Production Efficiency of average over expected |
| | production |
| total_phase_r_voltage | Simple average of the total_phase_r_voltage |
| | values in all parks at this instant |
| total_phase_s_voltage | As above, for phase s voltage |
| total_phase_t_voltage | As above, for phase t voltage |
| total_phase_r_current | Sum of the total_phase_r_current values |
| | in all parks at this instant |
| total_phase_s_current | As above, for phase s current |
| total_phase_t_current | As above, for phase t current |

### Configuration Database

The configuration database (named ‘configuration’) contains several database tables of configurable items for the system elements such as the substation, turbines, meteorological sites, parks, and so on. These tables are used by the system elements during initialization as well as by the DPA. The system configuration tables are described below.

TABLE dpa_classes

The dpa_classes database table contains one record for each class type used by the DPA. The DPA handles data reductions, alarm condition evaluation, and automatic control functionality for the TACS system.

| Field | Description |
|---|---|
| key | DPA class numeric identifier |
| name | Name |
| description | Description |

TABLE dpa_evaluation_groups

The dpa_evaluation_groups database table contains one record for each evaluation group used by the DPA. An evaluation group specifies the rate at which the DPA rules assigned to the group are evaluated.

| Field | Description |
|---|---|
| key | |
| name | |
| evaluation_period | Period in seconds that the DPA rules of this class |
| | will be evaluated. |

TABLE dpa_rules

The dpa_rules database table contains one record for each rule used by the DPA.

| Field | Description |
|---|---|
| key | |
| name | |
| description | Description |
| enabled | Flag set if this rule is enabled for processing |
| dpa_class | Class of this DPA rule. Used in the dpa_classes |
| | table to find the class record for this rule. |
| evaluation_group | Evaluation group for this DPA rule. Used in the |
| | dpa_evaluation_groups table to find the group record |
| | for this rule. |
| eval_proc_name | Name of the stored procedure for this DPA rule |
| | to evaluate. |
| has_action | If true, the action_proc_name |
| | stored procedure will be executed for each record in |
| | the result set. |
| action_proc_{—} | Name of the stored procedure to execute for this |
| name | DPA action. It is called once for each record returned |
| | from the evaluation. Not used if expect_result_set is |
| | false. |
| action_param_1 | If not NULL and has_action is true, this string |
| | is passed as the first parameter when the action_{—} |
| | proc_name stored procedure is called. |
| action_param_2 | If not NULL and has_action is true, this string is |
| | passed as the second parameter when the action_{—} |
| | proc_name stored procedure is called. |
| action_param_3 | If not NULL and has_action is true, this swing |
| | is passed as the third parameter when the action_{—} |
| | proc_name stored procedure is called. |
| action_param_{—} | If not NULL and has_action is true, this string will be |
| 4_fieldkey | used to look up a value in the result set which |
| | will then be passed as the fourth parameter when the |
| | action_proc_name stored procedure is called. |
| action_param_{—} | If both fields are not NULL and has_action is true |
| 5_special | then these field will create the fifth parameter |
| action_param_{—} | to be passed when the action_proc_name |
| 5_fieldkey | stored procedure is called. |
| action_param_{—} | If both fields are not NULL and has_action is true |
| 6_special | then these fields will create the sixth parameter to be |
| action_param_{—} | passed when the action_proc_name |
| 6_fieldkey | stored procedure is called. |

The fifth and sixth parameters may be created using one or more of the following combinations depending on the special and fieldkey strings.

| Special | Fieldkey | Description |
|---|---|---|
| NULL | NULL | No string is passed as the parameter in the action_{—} |
| | | proc_name stored procedure. |
| string | NULL | The action_param_n_special string is passed as |
| | | the n'th parameter when the action_proc_name |
| | | stored procedure is called. |
| NULL | string | The action_param_n_fieldkey string is used to |
| | | look up a value in the result set which will then be |
| | | passed as the n'th parameter when the action_{—} |
| | | proc_name stored procedure is called. |
| string | string | The action_param_n_fieldkey string is used |
| | | to look up a value in the result set which will |
| | | then be inserted in the action_param_{—} |
| | | n_special string replacing the special characters |
| | | ‘%s’ and the resulting string will then be passed |
| | | as the n'th parameter when the action_proc_{—} |
| | | name stored procedure is called. |

TABLE event_downtime categories

The event_downtime categories database table contains one record for each category of event downtime. The event downtime is the reason that the system was down (unable to produce power).

| Field | Description |
|---|---|
| key | Event downtime category numeric identifier |
| name | Name |
| description_key | A numeric identifier to the description of this |
| | downtime category. This number is used in the |
| | str_description_list table to identify a |
| | record (by the key field) containing the downtime |
| | category description (text). |

TABLE event_levels

The event_levels database table contains one record for each type of event level. The event level is used in event records added to the events database.

| Field | Description |
|---|---|
| key | Event level numeric identifier |
| name | Name of the event level |
| description_key | |

TABLE event_source_categories

The event_source_categories database table contains one record for each category of event source. An event source is a type of device that can add an event into the events database event_log table.

| Field | Description |
|---|---|
| key | Event source category numeric identifier |
| name | Name of the event source |
| description_key | |
| source_cfg_table | Name of the configuration table for the this source |
| | category |

TABLE event_system_sources

The event system_sources database table contains one record for each type of event source which is contained within the system category.

| Field | Description |
|---|---|
| key | Source numeric identifier for system events |
| name | Name |
| description_key | |

TABLE substation_configuration

The substation configuration database table contains one record for each substation.

| Field | Description |
|---|---|
| key | Substation numeric identifier |
| name | Name |
| Description | Description |

TABLE park_Configuration

The park_configuration database table contains one record for each park.

| Field | Description |
|---|---|
| key | Park numeric identifier |
| name | Name |
| description | Description |
| substation_number | Substation connected to this park. This number is |
| | used in the substation_configuration table to |
| | identify a record (by the key field) containing |
| | substation details. |

TABLE turbine_configuration

The turbine_configuration database table contains one record for each turbine.

| Field | Description |
|---|---|
| key | Turbine numeric identifier |
| name | Name |
| description | Description |
| park_number | Park containing this turbine. This number is used |
| | in the park_configuration table to identify |
| | a record (by the key field) containing park |
| | details. |
| provider_id | Provider identity for this turbine. This number is |
| | used in the provider_identity table to |
| | identify a record (by the key field) containing |
| | provider identity details. |
| tpu_configuration | Turbine processing unit class for this turbine. This |
| | number is used in the tpu_configuration table |
| | to identify a record (by the key field) |
| | containing TPU details. |
| provider_map_type | Provider map for this turbine. This number is used |
| | in the provider_map_types table to identify a |
| | record (by the key field) containing provider |
| | data mapping details. |

TABLE metmast_configuration

The metmast_configuration database table contains one record for each meteorological data logger.

| Field | Description |
|---|---|
| key | Meteorological data logger numeric identifier |
| name | Name |
| description | Description |
| met_type | The meteorological data logger numeric type. This |
| | value is used by the MPU listener to determine the |
| | correct communication protocol. |
| park_number | Park containing this meteorological data logger. |
| | This number is used in the park_configuration table |
| | to identify a record (by the key field) containing |
| | park details. |
| provider_id | Provider identity for this meteorological data |
| | logger. This number is used in the provider_identity |
| | table to identify a record (by the key field) |
| | containing provider identity details. |
| comm_port | Physical communication port used by the MPU |
| | listener for this meteorological data logger. |
| provider_map_type | Provider map for this meteorological data |
| | logger. This number is used in the provider_map_{—} |
| | types table to identify a record (by the key |
| | field) containing provider data mapping details. |

TABLE tpu_configuration

The tpu_configuration database table contains one record for each type of turbine controller.

| Field | Description |
|---|---|
| key | TPU configuration numeric identifier |
| name | Name |
| description | Description |
| controller_type | Turbine controller numeric type. Used by TPU to |
| | determine correct communication protocol and |
| | processing algorithms. |
| sample_period | Sample period (in milliseconds) for TPU to request data |
| | from turbine controller. |

TABLE provider_types

The provider_types database table contains one record for each data provider type. A data provider is a process that adds data to the database measurement repository.

| Field | Description |
|---|---|
| Key | Provider type numeric identifier |
| Name | Name |
| description | Description |
| cfg_table_name | Name of the configuration database table for |
| | this provider type. This name is used by the |
| | generice provider during the boot configuration |
| | process. |
| control_table_name | Name of the database table used by this provider |
| | to queue commands. |
| control_table key_{—} | Name of the key field (used to identify the |
| field | provider) when accessing the command queue |
| | specified by control_table_name. |

TABLE provider_identity

The provider_identity database table contains one record for each set of data providers writing to a specific database table. A data provider is a process that adds data to the database measurement repository.

| Field | Description |
|---|---|
| key | Provider identity numeric identifier |
| name | Name |
| description | Description |
| user_name | Provider login user name to access the database. |
| password | Provider login password to access the database. |

TABLE provider_maps_types

The provider_map_types database table contains one record for each unique provider map. A provider map tells the provider how to map the source data fields from a (e.g. from a TPU or MPU) to the correct database fields. This mapping is handled by a unique stored procedure in the repository database for each map type.

| Field | Description |
|---|---|
| key | Provider identity numeric identifier |
| name | Name |
| description | Description |
| stored_proc_name | Stored procedure name for this map type. |
| id | Map identifier for providers with multiple maps. |

TABLE operator_list

The operator_list database table contains one record for each operator of the TACS system.

| Field | Description |
|---|---|
| key | Operator numeric identifier |
| first_name | First name of the operator |
| last_name | Last name of the operator |
| login_username | Login user name of the operator |
| login_password | Login password for the operator |
| pager | Pager number for this operator |
| email | E-mail address for this operator |
| phone | Phone number for this operator |

TABLE str_language_list

The str_language_list database table contains one record for each language type represented in the str_description_list table. The str_description_list table contains text strings in one than one language.

| Field | Description |
|---|---|
| key | Language numeric identifier. This number is used in the |
| | str_description_list table to identify |
| | records (by the language_key field) which contain a |
| | description in this language. |
| language | Language name |

TABLE str_description_list The str_description_list database table contains text strings in one or more languages. Each record contains a key and a language_key field which can be used to find the same text string in any language which it is available.

| Field | Description |
|---|---|
| key | Numeric identifier for this text string description |
| language_key | A numeric identifier to the language of this |
| | description text string. This number is used in the |
| | str_language_list table to |
| | identify a record (by the key field) containing the |
| | language of this text string description. |
| description | Description in the language specified by the |
| | language_key. |

### Events Database

The events database is the repository for all types of events including configurable alarms. This database is named ‘events’. It includes the following table.

TABLE event_log

The event_log database table contains one record for each event in the event log.

| Field | Description |
|---|---|
| event_key | A unique identifier for the alarm |
| event_id | Event code (same as the DPA key number) |
| | for alarm events). |
| event_time | Date and time of the event in T-SQL datetime |
| | format. Has millisecond resolution. |
| event_level | A number representing the event level. Used |
| | in the event_levels table to identify |
| | a record (by the key field) containing event |
| | level details. |
| Source_category | Category of device that generated the event. |
| | Used in the event_source categories |
| | table to identify a record (by the key field) |
| | containing event source device details. |
| Source_number | The number of the source device. For example, |
| | if the source_category is TPU then |
| | this number represents the TPU identifier. If |
| | the source_category is Meteorological |
| | site then this number represents the MET identifier. |
| description | A description of the event added by the data |
| | processing agent when the event was detected. |
| downtime_category | The reason that this event has caused system |
| | down time (if any). This number is used in the |
| | event_downtime categories table (in the |
| | configuration database) to identify a record (by |
| | the key field) containing the system downtime |
| | details. |
| acknowledged | The acknowledge state of the event. TRUE if event |
| | has been acknowledged by an operator. Otherwise, |
| | FALSE. Acknowledging an event tells system that |
| | an operator has been successful notified of the |
| | event condition. |
| ack_operator | The key to the operator who acknowledged the |
| | alarm. Used in the operator_list table |
| | (in the configuration database) to identify a |
| | record (by the key field) containing the operator |
| | details (name, etc). |
| ack_time | The date and time the event was acknowledged. |
| event_comment | An optional comment which may be added by the |
| | operator when the event is acknowledged or cleared |

### Conclusion

The invention has been described in terms of particular embodiments. Other embodiments are within the scope of the following claims. For example, steps of the invention can be performed in a different order and still achieve desirable results. Because of its modular and open design, the system of the invention can be implemented using a variety of alternative technologies. Components subsystems can be implemented using different and multiple platforms. For example, the functions performed by the server can be performed by a single computer or distributed across multiple computers. The specific components and parameters provided in this specification are illustrative only and are not intended to be limiting.

What is claimed is:

1. A Supervisory Command and Data Acquisition (SCADA) system for managing a wind farm having an array of wind turbines for electric power generation and one or more meteorological sites, each wind turbine being located at a turbine site and electrically connected for power transmission to a substation located at a substation site, the system comprising:
a turbine processing unit (TPU) located at each wind turbine, the TPU being a processing element functioning as the SCADA element for that turbine, the TPU being configured to collect data from the turbine and turbine site, to provide an interface to control the turbine, and to communicate with other parts of the system from the turbine site, the TPU being further configured to store locally at the TPU data collected from the turbine and turbine site;
a substation processing unit (SPU) located at the substation operating as the interface for the system to the substation, the SPU being a processing element functioning as the SCADA element for that substation, the SPU being configured to collect data from the substation, to communicate with other parts of the system, and to store locally at the SPU data collected from the substation;
a meteorological processing unit (MPU) located at each meteorological site functioning as the SCADA element for the site, the MPU being configured to collect meteorological data from sensors on and at a meteorology tower, to communicate with other parts of the system, and to store locally at the MPU data collected from sensors on and at a meteorology tower;
a data communication network;
a server coupled to communicate over the network with the wind turbines, the substation, and the one or more meteorological sites, the server being configured to receive data from them through their respective the SCADA elements (TPU, MPU, or SPU) and to provide signals to control the wind turbines and substation through their respective SCADA elements, the server being further configured to store data received from the wind turbines, meteorological sites, and substation at regular intervals and to perform database management on the received data; and
a user interface through which authorized users can exercise command and control functions for the wind farm.

2. The system of claim 1, wherein:
the user interface is a graphical user interface (GUI) that can be accessed locally through a direct connection to the network or a direct connection to an element of the system.

3. The system of claim 2, wherein:
the user interface provides views to each SCADA element to allow users access to real time data and subsystem controls.

4. The system of claim 1, wherein:
the user interface is a graphical user interface (GUI) that can be accessed remotely over a wide area network such as the Internet.

5. The system of claim 3, wherein:
the user interface provides views to each SCADA element to allow users access to real time data and subsystem controls.

6. The system of claim 1, further comprising:
one or more control workstations, a workstation being a client computer of any kind, the one or more control workstations being configured to process data from the server and to provide real-time monitoring and control of the wind power system.

7. The system of claim 1, wherein:
one or more of the TPUs are configured to provide a connection for a portable device to allow a user of the portable device to communicate through the user interface with other components of the system.

8. The system of claim 1, wherein:
each TPU is configured to store data locally for a time sufficient to bridge any anticipated unavailability of the server.

9. The system of claim 1, wherein:
each TPU is configured to collect data including wind turbine controller state, wind speed, energy levels, and alarms; and
each TPU is configured to interact with the system through an Ethernet port and with workers working at the TPU through local ports.

10. The system of claim 1, wherein:
each TPU is built on a general purpose computer platform running a general purpose operating system; and
each TPU is configured to execute a client application providing local data collection and site control.

11. The system of claim 1, wherein:
the wind turbines comprise wind turbines that have turbine controllers that are proprietary to the respective wind turbine manufacturers and the TPU for each such turbine provides a uniform interface to the system from the proprietary turbine controllers.

12. The system of claim 11, wherein:
each TPU and its turbine controller are connected using an optically isolated connection.

13. The system of claim 1, wherein:
each TPU is connected to communicate with the server through an optical fiber.

14. The system of claim 1, wherein:
the SPU is configured to monitor the substation for discrete and analog inputs and the manage outputs set by the system.

15. The system of claim 1, wherein:
at least one meteorological site has a meteorology tower with sensors to monitor horizontal wind speed and direction from at least four levels above the ground, vertical wind speed, temperature, and atmospheric pressure.

16. The system of claim 1, wherein:
each MPU is built on a general purpose computer platform running a general purpose operating system; and
each MPU is configured to execute a client application providing local data collection and site control.

17. The system of claim 1, wherein:
each TPU, MPU, and SPU is configured to store the data collected by the unit over at least 48 hours of operation; and
the server is configured to store the raw data collected over at least two months of operation of the system.

18. The system of claim 1, wherein:
the turbines are grouped into parks.

19. A system for managing a wind farm having an array of wind turbines for electric power generation, the system comprising:
a Supervisory Command and Data Acquisition (SCADA) element at each wind turbine configured to collect data from the turbine;
a SCADA element at each of one or more meteorological sites configured to collect meteorological data; and
a SCADA element at each of one or more substations, the substations being electrically connected with the wind turbines for power transmission;
a server coupled to communicate with the wind turbine, meteorological, and substation SCADA elements, the server being configured to receive and to store data received from the elements at regular intervals and to perform database management on the received data, the server being further configured to gather and maintain detailed current and historical data as to the inputs, operating conditions, and outputs of all turbines of the wind farm at a high degree of time resolution.

20. The system of claim 19, wherein the data gathered at a high degree of time resolution comprises:
data including wind speed and energy production gathered from each wind turbine once a second;
meteorological data gathered from each meteorological site once every 30 seconds; and
substation data including power production each substation.

21. The system of claim 19, wherein the data gathered at a high degree of time resolution comprises:
wind turbine data including power, reactive power, wind speed, energy subtotal, and total energy data gathered from each wind turbine once a second.

22. The system of claim 21, wherein the wind turbine data further comprises:
data for each wind turbine representing generator rotational speed, generator temperature, gearbox temperature, ambient temperature, wind speed, wind direction, real power, reactive power, power factor, phase voltage and phase current for each phase, energy production, and production time.

23. The system of claim 20, wherein the data gathered at a high degree of time resolution further comprises:
data including controller state gathered from each wind turbine;
meteorological data including vertical and horizontal wind speeds, wind direction, temperature, and air pressure gathered from each meteorological site; and
substation data including total active energy out from the substation, total reactive energy out from the substation, total active energy into the substation, and total reactive energy into the substation.

24. The system of claim 19, wherein the wind farm is organized into parks for reporting and management purposes and the data gathered at a high degree of time resolution comprises:
the energy produced by each park.

25. The system of claim 24, wherein the data for each park includes data collected or calculating describing:
the operational status of each turbine in the park;
the total real power produced in the park;
the total reactive power produced in the park; and
the power factor for the park.

26. A system of claim 19, further comprising a configuration database for the wind farm, the configuration database containing information describing a current configuration of systems elements, the configuration information being used during system initialization, the configuration information comprising:
information describing the wind turbine configuration of the wind farm, the information describing all wind turbine SCADA elements in the wind farm.

27. The system of claim 26, the configuration information further comprising:
information describing each wind turbine of the wind farm, including for each such turbine data source information describing how source data from the turbine is to be mapped to fields in a system database.

28. The system of claim 26, wherein:
the information describing each wind turbine further includes for each such turbine a park identifier identifying a park containing the turbine.

29. The system of claim 26, wherein the SCADA element of each wind turbine is a turbine processing unit coupled to a turbine controller, the configuration information further comprising:
a turbine controller identifier for each turbine for determining correct communication protocols and processing algorithms between the coupled turbine controller and turbine processing unit.

30. The system of claim 26, the configuration information further comprising:
information describing each substation of the wind farm, the information including an identifier and a description for substation in the wind farm.

31. The system of claim 26, the configuration information further comprising:
information describing the meteorological sites of the wind farm, including for each site: a site identifier for determining correct communication protocols with the site, and data source information describing how source data from the site is to be mapped to fields in a system database.

32. The system of claim 26, the configuration information further comprising:
information describing the parks of the wind farm, including for each such park an identifier for the park, a description for the park, and information identifying the substations connected to the park and the wind turbines and meteorological sites in the park.

33. The system of claim 19, further comprising:
computer program processes configured to process wind turbine data to report average power production over a time window, expected power production over the time window, and production efficiency over the time window for each wind turbine in the wind farm.

34. The system of claim 19, wherein the wind farm is organized into parks for reporting and management purposes, the system further comprising:
computer program processes configured to process wind turbine data to report average power production over a time window, expected power production over the time window, and production efficiency over the time window for each wind turbine in each park.
